(19) United States
(12) Patent Application Publication
(10) Pub. No.: US 2011/0057025 A1
(43) Pub. Date: Mar. 10, 2011

(54) GENERATION, MANAGEMENT AND USAGE OF ON-DEMAND PAYMENT IDS

(75) Inventors: Karl Denzer, Denver, CO (US); William D. Young, Denver, CO (US)

(73) Assignee: PAYCODE SYSTEMS, INC., Denver, CO (US)

(21) Appl. No.: 12/554,443

(22) Filed: Sep. 4, 2009

(51) Int. Cl. G06F 17/00

(52) U.S. Cl. 235/375; 235/379

(57) ABSTRACT

There is disclosed a method, computer program and system that support purchase transactions at merchants via a Payment ID generated on-demand and funded with a specific consumer-requested amount. The Payment ID, which could include but is not limited to a gift card ID, is then leveraged to complete a transaction at a merchant's point of sale (POS) system via the existing methods and processes inherent in the POS system. Also disclosed are related mechanisms to manage a secure database of Payment IDs and dynamically adjust the value tied to Payment IDs to account for any value due the customer from the merchant or other involved party.

### TECHNICAL FIELD

This invention relates to closed loop payment systems, such as those leveraged to activate, fund and redeem gift cards to enable the purchase of goods and services at merchant locations. Additionally, this invention relates to systems that enable consumers to manage an individual profile using a mobile device via wireless communications networks.

### BACKGROUND OF THE INVENTION

Currently, many retailers and payment processors are attempting to create alternative payment models. This is being done to support two objectives: (1) create a convenient alternative to cash; and (2) reduce the cost and burden of current payment methods, including cash, credit and debit.

Two challenges have made the realization of these objectives difficult:

(1) Reliance on “open-loop” credit card networks (e.g., Visa, MasterCard, American Express). The simplest cash replacement is use of a credit card, which requires the merchant to pay a processing fee. This fee typically combines some fixed amount with a percent of the tender amount. As credit cards replace cash for smaller transactions (e.g. <$10), the fixed component of the fee represents a greater percentage of the tender amount, which significantly increases the average cost per transaction.

(2) Usage of “closed-loop” merchant gift cards. Gift cards are not processed by credit card networks and, as such, are less costly for the merchant. There are challenges, however, for the consumer. First, gift cards must be purchased or received in advance of a retail transaction, making the traditional gift card process inconvenient for real-time payments. Second, they are purchased for a specific amount, which is not tied to a specific transaction. As such, there is often some unused balance on the gift card which is effectively lost by the consumer (often referred to as “breakage”).

Many believe that supporting payments from mobile devices, such as a mobile phone, will enable more efficient and cost-effective payments. This has been difficult in large part due to challenges with the adoption of enabling hardware, which include the consumer devices such as Near-Field Communication (NFC)-enabled mobile phones, and merchant hardware such as contactless readers at merchants' POS systems.

### SUMMARY

Embodiments of the present invention overcome the above challenges as they: (1) enable a cost-effective alternative to cash payments; (2) support the growing trend of mobile payments without requiring costly hardware upgrades to merchants' POS systems; (3) represent a convenient payment process that allows the consumer to closely manage and monitor payments; and (4) reduce processing costs for merchants, which in turn enables economically viable options to reward customers for using this method.

Embodiments of the present invention are directed to a method and system that support purchase transactions at merchants via a Payment ID generated on-demand and funded with a specific consumer-requested amount. The Payment ID, which could include but is not limited to a gift card ID, is then leveraged to complete a transaction at a merchant's point of sale (POS) system via the existing methods and processes inherent in the POS system.

The Payment ID could be provided to the POS system via a manual entry of the ID as received and communicated by the consumer; scan of a bar code representing the Payment ID, which was rendered on a mobile device used by the consumer; wireless transmission of the Payment ID from a consumers mobile device and the merchant's POS; back-end system calls between a Central Processing System and the merchant's POS system; or other method that supports the transmission of the Payment ID to the merchant's POS system. Once the Payment ID is received by the Merchant's POS system, established processes that support payment card redemptions are invoked to complete the consumer's payment.

Methods and processes described herein also consider the management of a secure database that tracks multiple types of Payment IDs (e.g., one-time use, re-loadable, or previously funded) and assigns them to a specific consumer's account in advance or in during and active tender to support purchase transactions. Funds associated with a Payment ID will be drawn from a customer-funded account. This funding can involve debit transfers, credit charges, ACH transfers from a checking account, or other methods as requested by the consumer.

Embodiments of the present invention also include applications that enable customers to manage their mobile wallet, select participating merchants, initiate payment transactions, and manage their identity. Similar functionality also allows merchants to manage business logic that governs certain aspects of the interaction between the consumer and the merchant, which can include merchant-specific messaging, options for the customer to earn rewards from that merchant, promotions, discounts, or other merchant-directed function.

Furthermore, automated delivery of specific messages to the consumer is enabled, which can consider promotions, advertising, or rewards tied to a current or future transaction. In the case of a reward, value can include an immediate adjustment of the amount tied to a Payment ID to reflect a reduced purchase price, credit toward a future purchase, a cash rebate, accrued points redeemed for future value, or other items that are of value to the consumer.

These and other advantages will be apparent from the disclosure of the invention(s) contained herein. The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a flowchart illustrating a method to generate a payment ID on demand, which is funded in a specific, consumer-requested amount, and can be used immediately to process a payment at a merchant's POS;

FIG. 2 is a flowchart illustrating a method to transmit and redeem a Payment ID via a bar code or human readable number rendered on a consumer's mobile device;

FIG. 3 is a flowchart illustrating a method to transmit and redeem a Payment ID via direct integration with merchant POS system;

FIG. 4 is a flowchart illustrating a method to wirelessly transmit and redeem a Payment ID to a merchant's POS system from a consumer's mobile device;

FIG. 5 is a flowchart illustrating a method through which the consumer is authenticated to initiate an interaction session with the System, and his or her profile is retrieved for use during that session;

FIG. 6 is a flowchart illustrating a method to retrieve, manage and secure merchant-specific Payment IDs from the processors of those Payment IDs;

FIG. 7 is a flowchart illustrating several embodiments of a method to enable a consumer to access and manage Payment IDs and account balances in his/her mobile wallet;

FIG. 8a is a flowchart illustrating a method to dynamically associate messages, including reward promotions and coupons, to a Payment ID;

FIG. 8b is a second flowchart illustrating a method to dynamically associate messages, including reward promotions and coupons, to a Payment ID; and

FIG. 9 is a flowchart illustrating a method to dynamically alter the amount associated with a Payment ID to reflect the dynamic application of a promotion.

### DETAILED DESCRIPTION OF THE DRAWINGS

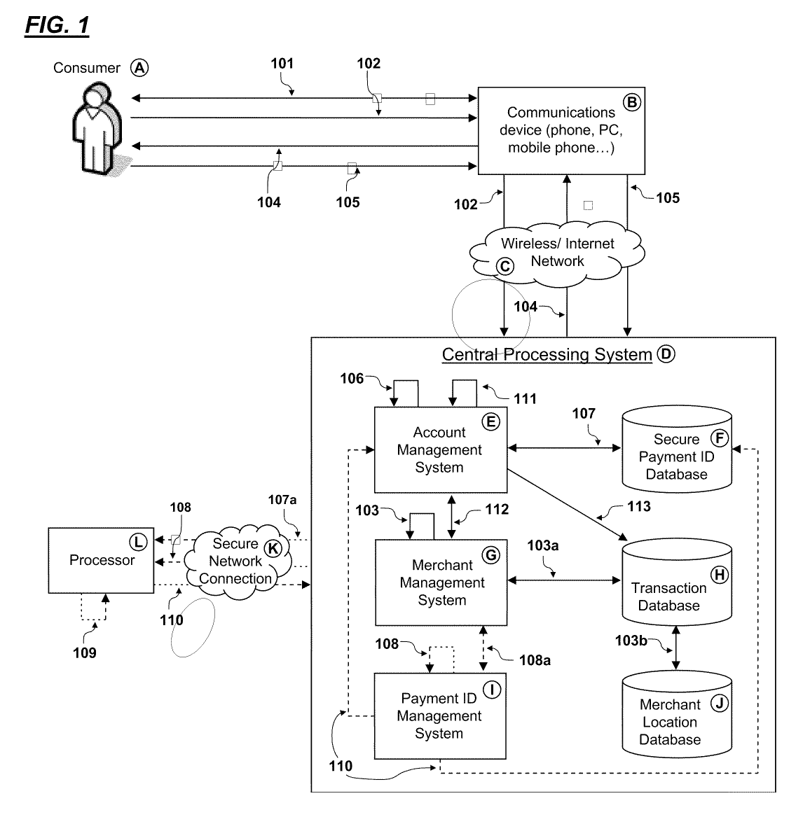

A method of generating a payment ID in real time, which is funded in a specific consumer-requested amount, is illustrated in FIG. 1. At step 101, the method considers the interaction between the consumer (element A) and a communication device (element B) to initiate the dynamic creation of a Payment ID. The consumer (element A) can be any individual wishing to process a transaction through a merchant point-of-sale system, be it within a physical location or through a virtual interface; and the communication device could be a mobile phone, a computer, a land-line phone or other personal communication device (element B). This interaction may leverage a software application that resides on the communications device (element B), or may depend entirely on a software application that is hosted remotely and accessed through a network connection. Specific interaction with the software application will be governed by the type and functionality of the communications device, and may include use of a keyboard, touch-screen, trackball, voice commands, or other method of input.

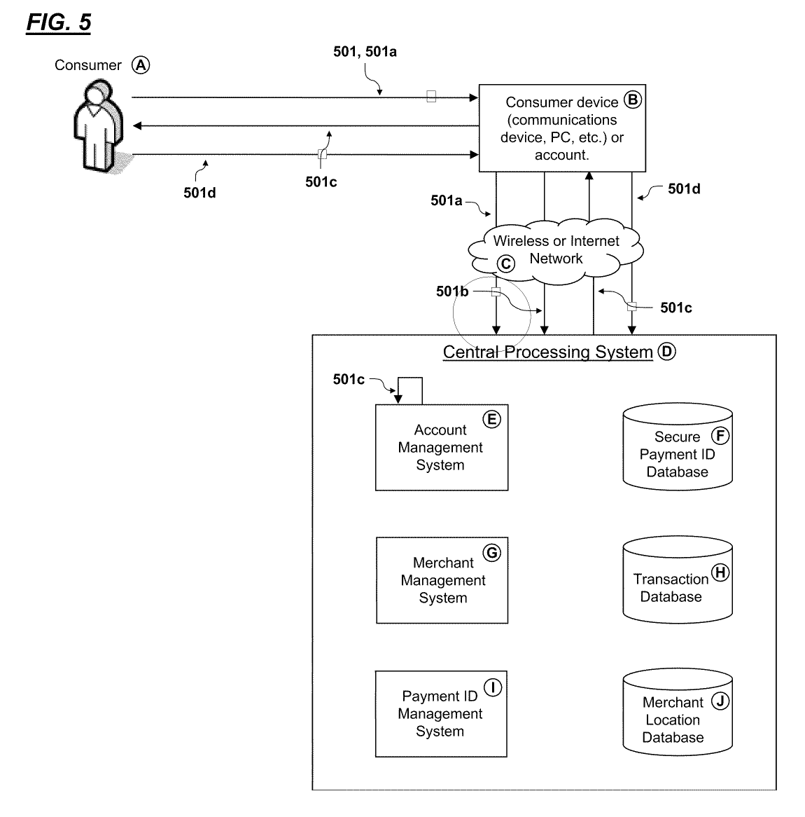

At step 102, the customer (element A) indicates that that he/she would like to make a payment in at a merchant location, and this indication is sent to the Central Processing System (element D) via a wireless or Internet network (element C). The Central Processing System (element D) is a physical environment which contains both the hardware and software required to handle all processes and methods considered within this document. The wireless, phone or Internet network (element C) is the medium over which transmissions are exchanged between the consumer's communications device (element B) and the Central Processing System (element C). This indication triggers the authentication method detailed in FIG. 5. Once this authentication process is completed, the customer (element A) may use the system to generate a Payment ID via the method and process detailed herein.

At step 103 the Merchant Management System (element G, contained within the Central Processing System) generates a list of merchants at which payments can be accepted. The Merchant Management System (element G) houses information unique to each merchant, which enables the Central Processing System (element D) to process transactions effectively for that merchant. This information may include, but is not limited to, merchant name; merchant-specific format of codes, such as UPC or transaction ID; required messaging sequence for each merchant; processing parameters for each merchant such as direct transmission vs. transmission via a consumer-delivered code; the time window during which a Payment ID remains usable; and any other information unique to a merchant that is required to manage individual transactions.

In one embodiment of this method, a default list is generated by the Merchant Management System (element G) (step 103), which places the merchants in a priority order based on factors independent of the individual user. For example, the default priority of the list may be based on the size of the retailer (e.g., a coffee chain with 10,000 locations would appear before a convenience store with 500 regional locations); the total number of purchases made at a retailer; or based on any other rule incorporated within the Merchant Management System (element G). Step 103a represents another embodiment of this method in which the list of merchants is generated and prioritized based on the consumer's recent purchase activity. This is done via interaction between the Merchant Management System (element G) and the Transaction Database (element H) to determine recent activity of the individual user. The Transaction Database (element H) contains a record of all transactions, and can be queried to pull information by customer, merchant, day, geography, amount, or any other variable tied to individual transactions. This interchange enables the Merchant Management System (element G) to reference the consumer's purchase activity when creating a prioritized list of merchants (e.g., the 6 merchants at which the customer has made recent purchases could be listed in order of most purchase activity to least). Step 103b represents a further embodiment of this method in which the list of merchants is prioritized based on the consumer's physical location at the time the initial payment request is made. This is possible provided the communications device is able to detect physical location leveraging GPS or some other location-deterministic technology. In this embodiment, the communications device would transmit the physical location of the consumer to the Central Processing System (element D), which would invoke an interaction between the Merchant Management System (element G) and the Merchant Location Database (element J). The Merchant Location Database is a discreet set of data tied to individual merchants that includes ZIP Code, ZIP+4 Codes, latitude/longitude coordinates, and other data required to pinpoint a merchant's physical location as accurately as possible. This interaction ties the consumer's location to the merchant location such that a single merchant, or small list of potential merchants, can be displayed that represent the consumer's likely location.

At step 104, the Central Processing System (element D) submits the list of merchants generated at Step 103 for display on the consumer's communications device (element B) such that it can be reviewed by the consumer (element A). This method considers the formatting of the list such that it is effectively rendered on the consumer's communications device. This formatting is done in accordance with the requirements and capabilities of the consumer's specific device, which can consider graphical content hosted by the Central Processing System (element D) and accessed via a network connection, or content delivered to the mobile device and then formatted for display via an application resident on the device.

At Step 105, the consumer (element A) provides required information to the Central Processing System (element D) via his/her communications device (element B). This information may include, without limitation, (1) the specific merchant at which he/she would like to make a purchase (provided via selection from the prioritized list received at Step 104); (2) the specific amount of that purchase; and (3) any other data required to generate a specific payment ID. Selection of the merchant and entry of the specific purchase amount is done in accordance with the operating software resident on the communications device, which may include a touch screen, keyboard, tracking ball, voice command or other type of interaction. Both the merchant and the purchase amount are associated with the individual transaction, and referenced throughout the remainder of the transaction.

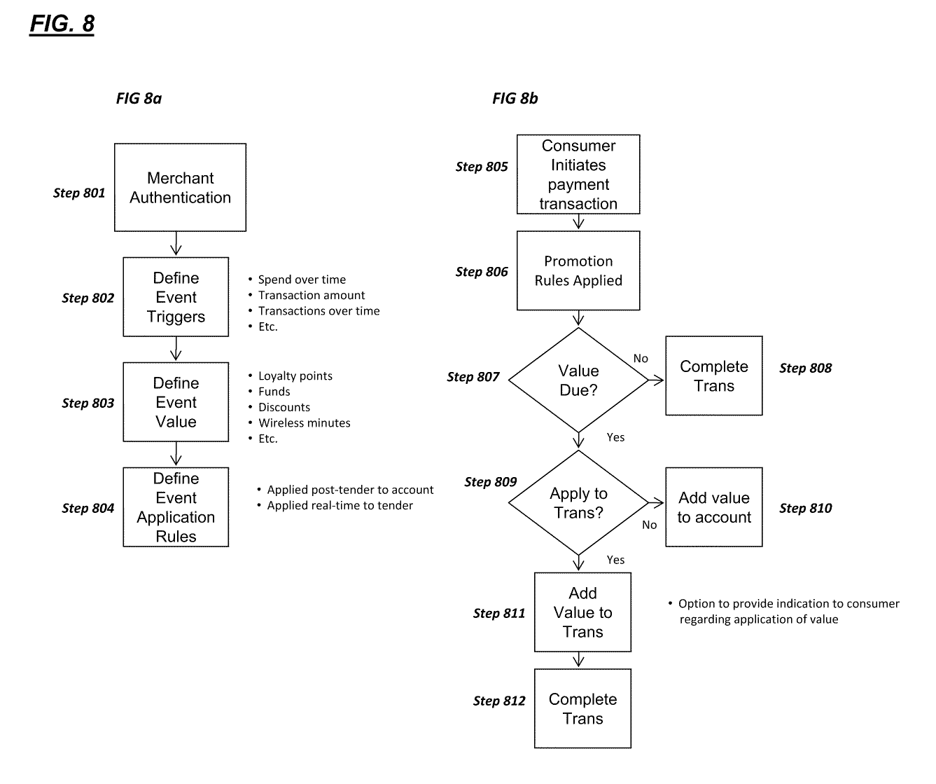

At step 106, the Account Management System (element E), contained within the Central Processing System (element D), verifies that the consumer has access to the funds required to complete the transaction in his/her account. The Account Management System (element E) contains information tied to individual consumers, which is accessed and maintained to manage the identity of individual users of the system and to enable individual transactions. This information includes name; contact information; preferences such as payment method, contact method and frequented merchants; account numbers; and other data which can be leveraged to support an individual consumers interaction with the Central Processing System (element D). This method (step 106) involves two steps: (1) the Account Management System (element E) identifies if there are any existing Payment IDs linked to the consumer and the merchant, which can be leveraged in the current transaction; then, if needed, (2) the Account Management System (element E) confirms that the consumer has a sufficient balance of funds available for dynamic application to an unused Payment ID. Existing Payment IDs could be previously-funded Payment IDs that are specific to the selected merchant and resident within the consumer's account (as indicated by the Account Management System); or they could be Payment IDs that have been previously used by that consumer at that merchant, and which can be re-loaded and re-used. Previously funded Payment IDs are provided and managed by the consumer via the method detailed in FIG. 8. If the consumer does not have an existing Payment ID or sufficient funds in their account, a separate method—which is detailed in FIG. 8—is invoked to provide the consumer with available options.

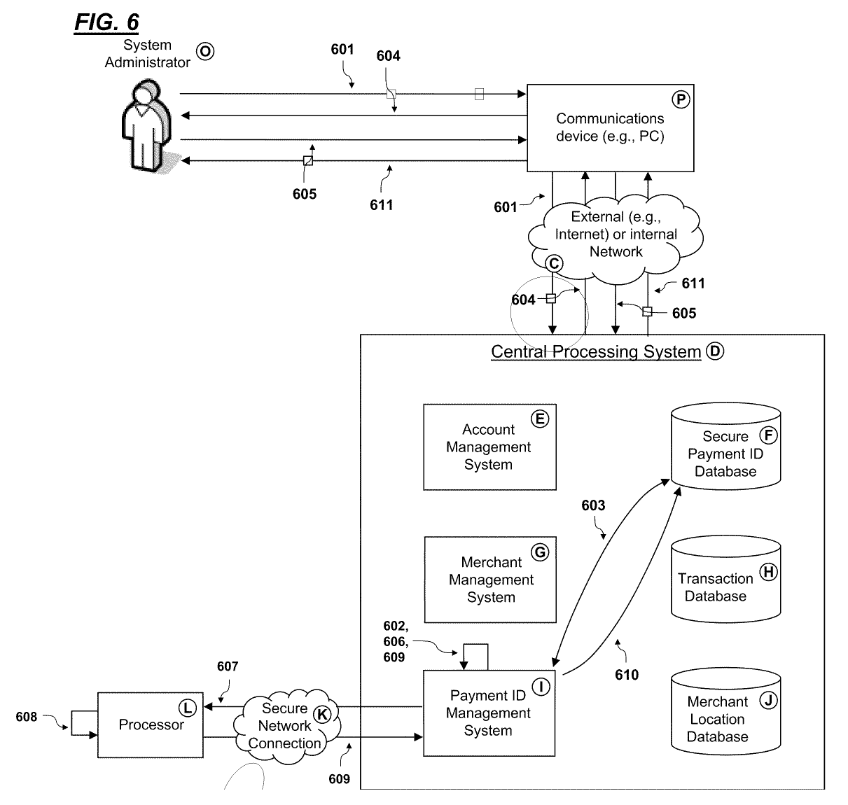

At Step 107 the Account Management System (element E) interacts with the Secure Payment ID Database (element F) to retrieve the specific Payment ID to be used in the current transaction. The Secure Payment ID Database (element F) houses individual Payment IDs that can be used to process individual transactions across merchants. This information is held separate from other information contained within the Central Processing System (element D) to ensure it is protected to the fullest extent possible. The Payment ID retrieved is either an existing or unused Payment ID, as identified Step 106. This Payment ID can then leveraged for a purchase transaction by the specific merchant's point of sale system. The method by which the Secure Payment ID Database (element F) is populated with Payment IDs is detailed in FIG. 6.

If the retrieved Payment ID is unused, Step 107a may be invoked in which a message containing the Payment ID and consumer-requested amount is sent by the Central Processing System (element D) to the relevant Processor (element L). The Processor (element L) is the entity responsible for handling a specific merchant's closed-loop transactions, such as payments that leverage a gift card ID. Exemplary processors (element L) may include, without limitation, third parties, such as First Data Corporation or Stored Value Systems (SVS) or, in some cases, may be the merchants themselves. In the case of gift card IDs, the Processor typically generates the IDs, associates an amount to each ID, and authorizes the use of a specific gift card ID to support a payment transaction via a message transmitted by the merchant to the Processor during a tender at the merchant's POS system. This step 107a may be required by some Processors and Merchants such that the Processor's systems have advanced knowledge of the amount for which a Payment ID is authorized.

Interaction between the Central Processing System (element D) and the Processor (element L) may be enabled via a Secure Network Connection (element K). This Secure Network Connection (element K) is a connection between the two entities, which ensure a safe transmission of secure data that can not be easily compromised by outside parties.

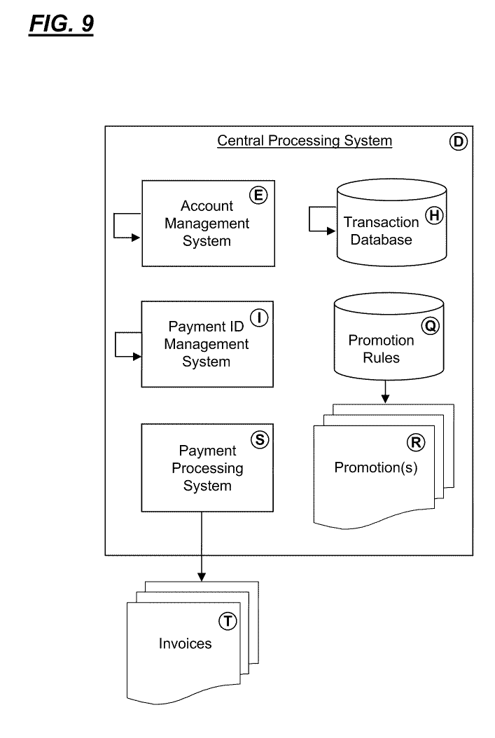

In many uses, the specific purchase amount tied to the Payment ID will be identical to the amount requested by the consumer in Step 105. In some cases, however, the amount may differ in order to adjust for a promotion that is associated with the transaction. The methods for associating promotions with specific transactions, and for dynamically adjusting the amount tied to a Payment ID, are detailed in FIGS. 8 and 9, respectively.

If a Payment ID is successfully retrieved in Step 107, this process skips to Step 111. If not, the separate method detailed in Steps 108, 109 and 110 is invoked to retrieve a Payment ID from an external source as part of the active transaction.

At Step 108 the Payment ID Management System generates a request for a Payment ID to the Processor, which is transmitted to the Processor (element L) by the Central Processing System (element D) via the Secure Network Connection (element K). The association between the merchant and the relevant Processor is contained within the Merchant Management System (element G), and retrieved by the Payment ID Management System in Step 108a. The request submitted to the Processor in Step 108 includes the merchant for which the Payment ID is to be generated, the specific amount for which the Payment ID is to be authorized and funded, and any other information required to produce the Payment ID.

At Step 109, the Processor retrieves a Payment ID from its internal systems, and authorizes it for use in the requested amount. This specific process may vary by Processor, and is entirely dependent upon the Processor's internal systems.

At Step 110, the Processor (element L) transmits the Payment ID to the Central Processing System (element D) via the Secure Network Connection (element K). The Payment ID is then transmitted to the Account Management System (element E) via the Payment ID Management System for use during the current transaction. The Payment ID is also transmitted to and stored within the Secure Payment ID Database (element F).

At Step 111 the Account Management System (element E) associates the consumer-requested funding amount to the Payment ID, and deducts this amount from the relevant customer account—which could be a prepaid account, a previously provided credit card, or some other specific account and process established by the method described in FIG. 8. At Step 112 the Account Management System (element E) interacts with the Merchant Management System (element G) to retrieve a specific “shelf life” for the Payment ID, if any. This “shelf life” is a specific time window during which the Payment ID can be leveraged by the consumer for a transaction at the corresponding merchant. The duration of the shelf life is determined by business logic dictated by the merchant, the Processor (element L), or some other involved entity that wishes to govern the use of the Payment ID to mitigate fraud, drive usage behavior, or to meet some other business objective. The shelf life is then associated with the Payment ID within the Account Management System (element E).

At Step 113, the creation of the Payment ID and the deduction of the corresponding funds from the consumer's account is logged within the Transaction Database such that the information is available for subsequent viewing, reporting, reconciliation, invoicing, etc.

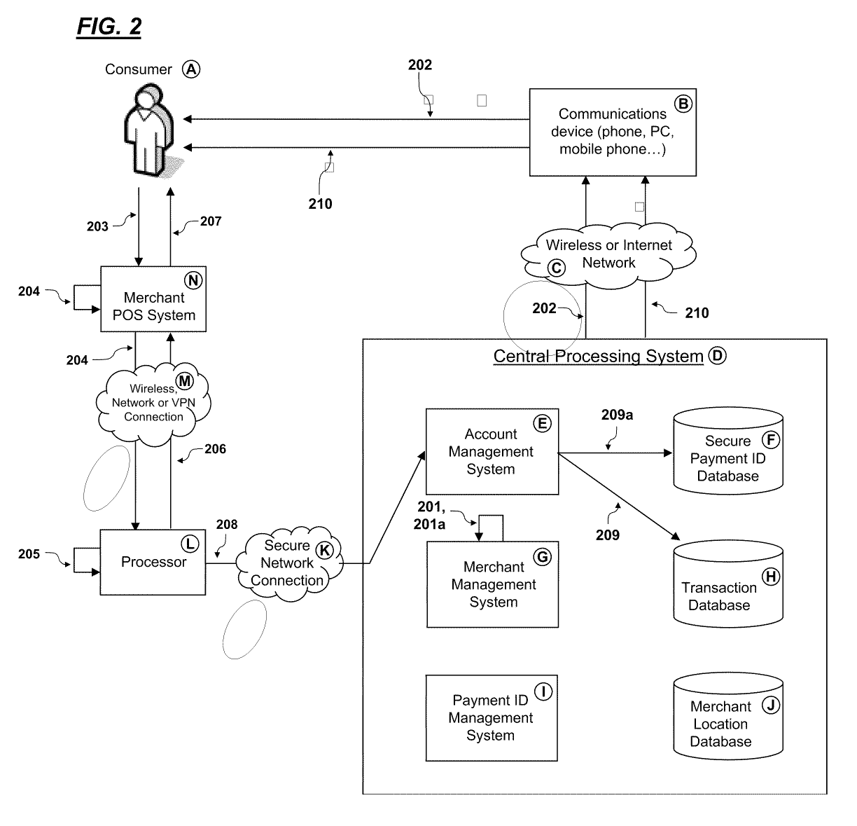

Once the Payment ID is generated for a specific merchant, authorized for use in the specific consumer-requested amount, and the relevant customer account balance has been reduced by the funded amount, the Payment ID can be leveraged to complete a purchase transaction at the merchant. Various methods for completing a purchase transaction are detailed in FIGS. 2, 3 and 4.

As can be seen in FIG. 2 and subsequent figures discussed herein, certain system elements depicted and described in connection with multiple figures have been provided assigned common element numbers. One skilled in the art will appreciate, however, that this identification scheme is used for clarity and ease of understanding the various embodiments provided herein. This numbering scheme is not intended, nor should it be construed as limiting the scope of the invention. Particularly, similarly designated elements may actually vary from system to system depending upon the system's implementation. Furthermore, one skilled in the art will appreciate that the functions of multiple elements may be combined into a common element or various other configurations not discussed herein. Likewise, functions of a single element described herein may be executed by multiple different elements without departing from the spirit of the present invention.

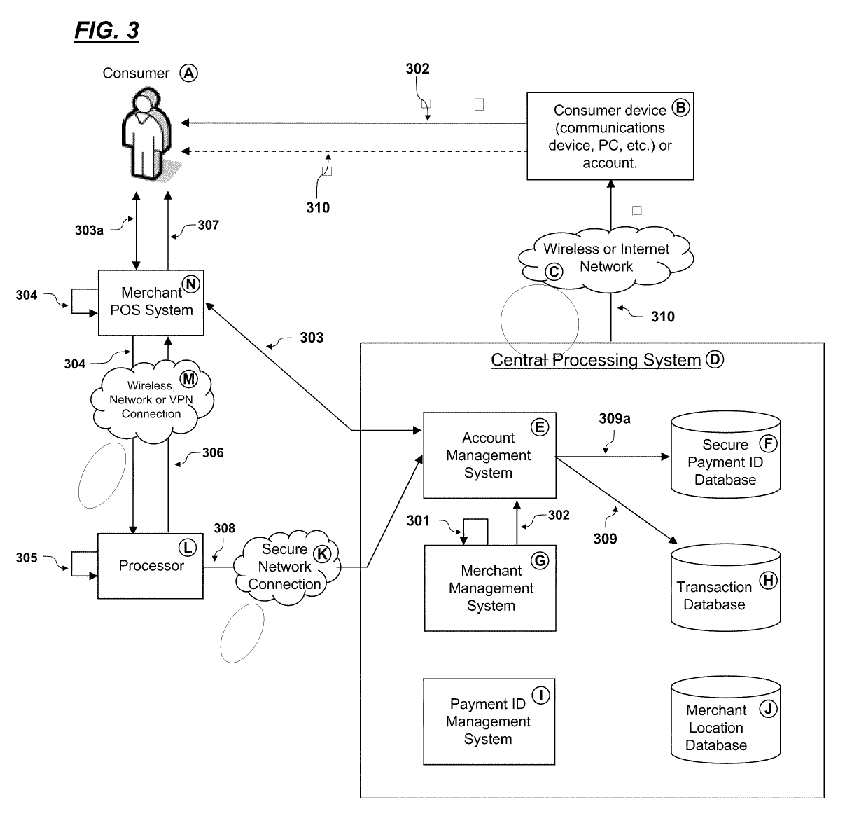

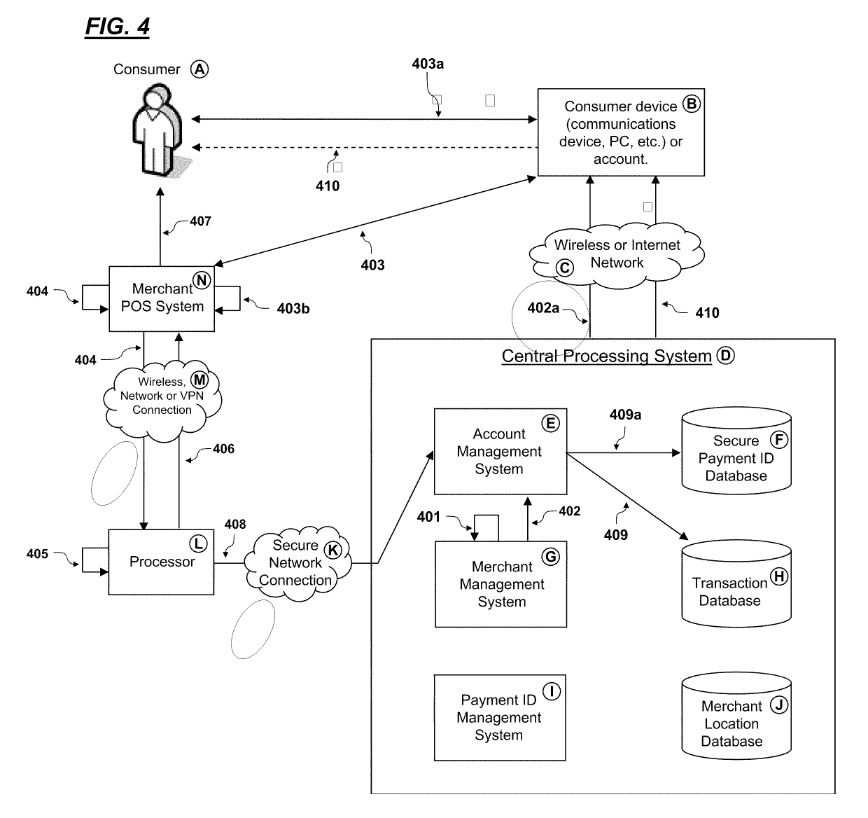

A method of using a Payment ID to support a real time transaction at a merchant's Point of Sale (POS) system via data transmitted to a consumer's wireless device such as a mobile phone or a PDA is illustrated in FIG. 2. At Step 201, the Merchant Management System (element G) looks up the specific transaction process for the merchant at which the transaction is occurring. This transaction process could involve the Payment ID being visibly or audible rendered as data on a consumer's mobile device, which is then manually provided to the Merchant's POS System (element N, such as is considered in this method); direct, back-end submission of data to the Merchant's POS System (element N, such as is considered in FIG. 3); data provided to a consumer's device for automated transmission to the Merchant's POS System (element N, such as is considered in FIG. 4); some combination of the three methods; or some other method through which data is passed to the merchant to process a specific transaction.

If it is determined in Step 201 that the merchant process involves data rendered on the consumer device in some user or machine-perceptible form, Step 201a is invoked, in which the type and format of data required by the specific merchant is looked up by the Merchant Management System (element G). This could consider a scanable bar code, numeric code in human readable format, audibly spoken or enunciated format, or some other type of data that can be recognized by the consumer, merchant employee or POS system. Additionally, the required format of the data is retrieved, which could include a bar-code font (e.g., code 39, 128, 11, etc.); size and font of a numeric code; specific dimensions of a graphic; or other guidelines required for the proper rendering and use of the data provided to the consumer's Communications Device (element B).

At Step 202, the data representing the Payment ID is passed to the consumer's Communications Device (element B) and displayed such that it can be leveraged to support a transaction at the corresponding merchant. The display of the data will be governed by the consumer's device and the software resident on that device. At Step 203, the data is input into the Merchant Point of Sale System, or POS, (element N) such that a transaction can be processed. The Merchant POS System (element N) is the system within the specific merchant that processes individual consumer transactions, which most often includes payment transactions for products or services. The Merchant POS System (element N) can represent a proprietary system built and managed by the merchant, or it can be a third-party system installed and managed by the manufacturer, such as NCR or IBM. The Merchant POS System (element N) can represent a distributed network with terminals accessed at physical checkout locations, a central system accessed via an e-commerce Web interface, a system used by an IVR or customer support representative to support sales by phone, or other structure that enables a consumer to transact with the merchant. Data can be input into the Merchant POS System (element N) by the customer, a sales associate or other relevant party, and can include an optical scan of a graphic (such as a barcode), the input of a numeric code via a keyboard, voice recognition, or other method.

At Step 204, the Merchant's POS System (element N) processes the data such that the Payment ID can be recognized or retrieved, and transmits the Payment ID to the Processor (element L) via a Wireless, Network or VPN Connection (element M). The Wireless, Network or VPN Connection (element M) is the connection that enables communication between the Merchant POS System (element N) and the Processor (element L) and may represent a standard wireless or Internet connection, a dedicated circuit, a Virtual Private Network (VPN) or some other type of connection that supports data transmissions. In some cases, the amount of the transaction will be submitted to the Processor (element L) with the Payment ID; however, this may not always be the case. At Step 205 the Processor (element L) will process the Payment ID to (1) confirm that the Payment ID is valid; (2) confirm that it is authorized for an amount at least as much as the transaction—provided the transaction amount was transmitted to the Processor (element L); and (3) perform any other verification steps required to enable the transaction and subsequent reporting, reconciliation, settlement, etc.

When the Payment ID is validated by the Processor (element L), at Step 206 a message is transmitted by the Processor (element L) to the merchant confirming that the transaction can be completed using the Payment ID. This message conforms to the standard interaction between the merchant and the Processor, and will vary based on which Processor (element L) and merchant are involved. At Step 207 the transaction is completed and the merchant provides the Consumer (element A) a transaction record in a manner consistent with the standard transaction processes at that merchant.

At Step 208, which may occur at the same time as Step 206 and Step 207, the Processor (element L) transmits a message to the Account Management System (element E) within the Central Processing System (element D) to confirm that the Payment ID was successfully used to complete the merchant transaction. This message may include the Payment ID, transaction amount, time, merchant location, and any other information pertinent to the individual transaction. At Step 209 data regarding the completed transaction is submitted to the Transaction Database (element H) to be used for subsequent reporting, reconciliation, settlement, etc.; and at Step 209a data is sent to the Secure Payment ID Database (element F) to ensure the status of the Payment ID reflects its use in the transaction.

At Step 210 a message is transmitted to the consumer's Communications Device (element B) to provide a final confirmation of the successful transaction. This message may include merchant, transaction amount, date and time, remaining account balance, and any other information required to summarize the transaction for the Consumer (element A). Once the consumer reviews this information the process of using the Payment ID to complete a merchant transaction is complete.

A method of using a Payment ID to support a real time transaction at a Merchant's Point of Sale (POS) System (element N) via data transmitted directly to a Merchant's POS System (element N) is illustrated in FIG. 3. Consistent with FIG. 2, Step 301 is invoked to look up the specific transaction process for the merchant at which the transaction is occurring. If it is determined that the merchant process involves data transmitted directly to the Merchant POS System (element N), Step 302 is invoked, in which the message sequence, format and contents specific to that merchant are retrieved from the Merchant Management System (element G). Then at Step 303, the Central Processing System (element D) and the Merchant's POS System (element N) exchange data specific to an individual transaction according to the parameters retrieved in Step 302. The data in the message(s) may include a unique transaction ID, which is generated by either the merchant or the Central Processing System (element D); a unique customer identifier (provided by the consumer during or prior to the transaction), the Payment ID, the amount, and any other information required to enable the transaction to occur and link it to a unique event and consumer.

At Step 303a, if required, information is exchanged between the Merchant POS System (element N) and the consumer to complete the transaction. This could include the collection of specific data for inclusion into the messages exchanged between the merchant and the Central Processing System (element N) as part of Step 302, or it could include data to summarize and confirm transaction details prior to finalizing the transaction.

Step 304 to Step 309 are consistent with Step 204 to Step 209, and govern the interaction between the merchant's POS and the Processor (element L); between the Central Processing System (element D) and the Processor (element L); and between the Merchant's POS System (element N) and the Consumer (element A). The process differs at Step 310, however, in that final confirmation of the transaction does not necessarily involve a mobile device, and may also be transmitted via an email, transmitted to a central database for subsequent access, or any other method available to the Consumer (element A). Once this information is made available to the consumer the process of using the Payment ID to complete a merchant transaction is complete.

A method of using a Payment ID to support a real time transaction at a Merchant's Point of Sale (POS) System (element N) via data transmitted wirelessly between a Consumer's Communication Device (element B) and a Merchant's POS System (element N) is illustrated in FIG. 4. Consistent with FIG. 2, Step 401 is invoked to look up the specific transaction process for the merchant at which the transaction is occurring. If it is determined that the merchant process involves data transmitted wirelessly between the Merchant POS System (element N) and a Consumer's Communication Device (element B), Step 402 is invoked, in which the data and message type specific to that merchant are retrieved from the Merchant Management System (element G). Then at Step 402a, the Central Processing System (element D) transmits data to the Consumer's Communications Device (element B) via a Wireless or Internet Network Connection (element C). The data transmitted may include a unique transaction ID, which is generated by either the merchant or the Central Processing System (element D); a unique customer identifier, which is provided by the consumer during or prior to the transaction; the Payment ID; the amount; and any other information required to enable the transaction to occur and link it to a unique event and consumer. The data is then processed by the Consumer's Communications Device (element B) as directed by the software resident on that device.

At Step 403 data is exchanged wirelessly between the Consumer's Communications Device (element B) and the Merchant's POS System (element N). This may occur automatically, or the process may require Step 403a, in which the consumer interacts with the Communications Device (element B) to trigger transmission of the message; and/or Step 403b, in which the Merchant POS System (element N) performs an operation to trigger the transmission of the message.

Step 404 to Step 410 are consistent with Step 204 to Step 210, and govern the interaction between the Merchant's POS System (element N) and the Processor (element N); between the Central Processing System (element D) and the Processor (element L); and between the Merchant's POS System (element N) and the Consumer (element A). Once confirmation details for the transaction are made available to the consumer the process of using the Payment ID to complete a merchant transaction is complete.

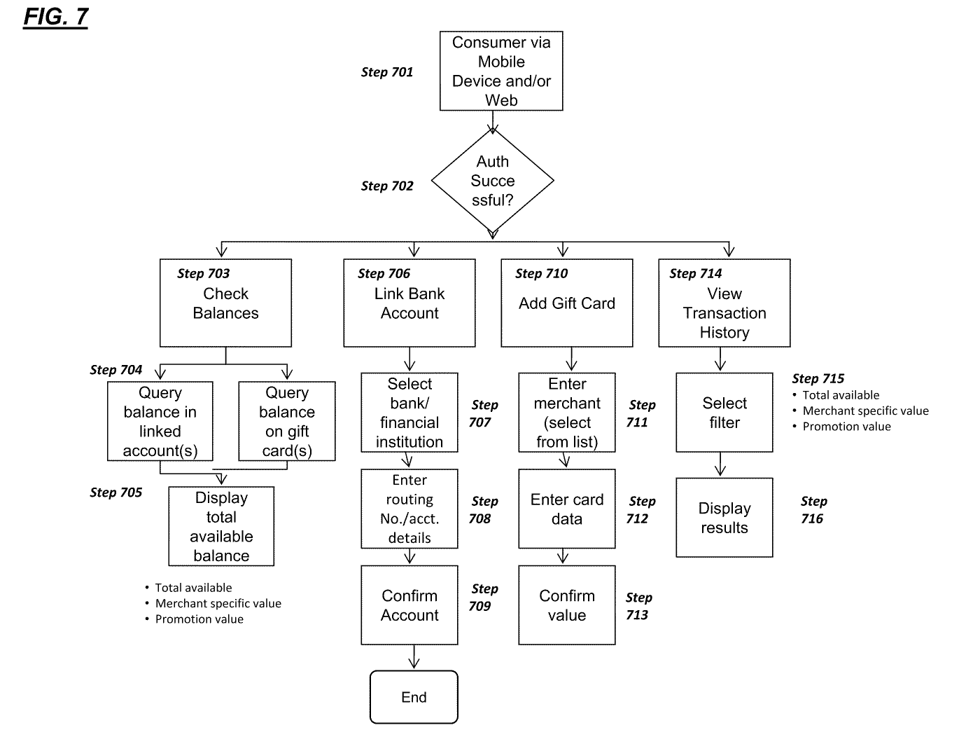

A method of using a consumer device to authenticate an individual user is illustrated in FIG. 5. At Step 501, the consumer indicates that he/she wishes to initiate a session with the Central Processing System (element D). The Consumer (element A) would initiate a session to either make a purchase transaction, which invokes the method detailed in FIG. 1, or to manage or review his/her account, which invokes the method detailed in FIG. 7. In one embodiment of this method, as represented in Step 501a, the Consumer (element B) initiates an authentication process via an application resident on the Consumer's Communications Device (element B), which may be a mobile communications device, a PC or other relevant hardware. In this embodiment, the application resident on the Communications Device (element B) requests that the consumer enter some identifying data, such as a user name or password, which is then submitted to the Central Processing System (element D). In another embodiment of this method, as represented in Step 501b, the consumer's device accesses an application hosted by the Central Processing System (element D) via a Wireless or Internet connection (element C). At Step 501c, which is part of this second embodiment, the Account Management System (element E) retrieves the information required from the Consumer (element A) and transmits a message to the Consumer's Communication Device (element B) requesting specific data that must be collected to authenticate the Consumer (element A). At Step 501d this required data is input by the consumer and transmitted to the Central Processing System (element D).

Once the required data is received by the Account Management System (element E), Step 502 is invoked, in which the data received is matched with the consumer-specific data contained within the Account Management System (element E). If there is an appropriate match, the Consumer (element A) is authenticated and a confirmation is sent to the Consumer (element A) at Step 503.

Once the authentication is confirmed, the Consumer (element A) is able to proceed with the desired payment or account management transaction(s).

A method of retrieving, managing, and securing merchant-specific Payment IDs from the processors of those Payment IDs is illustrated in FIG. 3. At step 601, a System Administrator (element O) accesses the Central Processing System (element D) using a Communications Device (element P), and provides information required to authenticate the user. The System Administrator (element O) may represent the merchant, the Processor (element L), the entity responsible for executing the methods in the present invention, or other party involved in the management of transactions. The Communications Device (element P) for this method may be any device that enables interaction between the System Administrator (element O) and the Central Processing System (element D), such as a personal computer, IVR system, wireless device or any other device. At step 602, the System Administrator's (element O) credentials are validated by the Payment ID Management System (element I), which grants access to use the Central Processing System (element D) and allows the functions appropriate to the level of permission associated with that user.

At step 603, the Payment ID Management System (element I) access the Secure Payment ID Database (element F) to retrieve the current inventory of Payment IDs, which can include remaining inventory of inactive IDs by merchant, active and re-loadable IDs by merchant, activation history by merchant and other data as necessary for assessing available inventory levels.

At step 604, this information is returned to the System Administrator (element O) who leverages it to take a number of actions, which include requesting additional card IDs, requesting or editing alerts should the inventory of card IDs reach a specific level, or any other steps that are required to facilitate the acquisition and use of card IDs by the Central Processing System (element D). This request is delivered to the Central Processing System (element D) at step 605.

At step 606, the Payment ID Management System (element I) will generate messages required to request Payment IDs (in bulk or individually) from the Processors (element L) of the Payment IDs. Specific messages will be generated for each Processor (element L), as each processor system will have unique requirements for the formatting, content and transmission protocol. These messages will also include authentication information as required by the processor and, in some cases, may require a separate transmission to validate the specific user of the Central Processing System (element D).

At step 607, the request is sent to the appropriate Processor(s) (element L) via the Secure Network Connection (element K), leveraging the transmission protocol required by that Processor (element L), which could include SOAP, XML, HTTP post, FTP or other approved method delivered in real-time, batch files or some other designated mechanism. At step 608, the processor processes the request and, if the request is properly authenticated, will generate a file of Payment IDs to be sent to the Central Processing System (element D).

At step 609, the file with Payment IDs and other information as deemed necessary is sent to the Central Processing System (element D) via the Secure Network Connection (element K), leveraging the appropriate transmission protocol and format.

At step 610, the file of payment IDs is received and processed by the Payment ID Management System (element I), and information is sent to the Secure Payment ID Database (element F) such that the Payment IDs are available to support additional transactions.

At step 611, a confirmation of the transaction is sent to the System Administrator (element O), and the process is complete.

FIG. 7 details a method by which the consumer interacts with the Mobile Wallet application to check and manage their account. At step 701, the consumer authenticates into the system using their pre-established security information. At step 702 the central processing system determines if they authenticate correctly, and if so, the consumer is then able to select from functions that enable them to link a bank account to their mobile wallet, check balances, view transaction history, and add gift card value.

At step 703 the customer is able to access a menu that enables them to check balances that are available for tendering transactions. Upon selecting this option, at step 704 the central processing system queries the balance contained in any bank account(s) that are linked to the customer's Mobile Wallet, as well as querying the balance available for any gift card IDs that are associated with the Mobile Wallet. At step 705, the central processing system returns the amount of funds available for display on the consumer's mobile device, Web page, or other authorized device.

At step 706 the customer is able to link an account from a 3^{rd} party financial institution to their Mobile Wallet. At step 707 the consumer selects from a list of available financial institutions, and at step 708 they enter the required account information, including but not limited to ABA routing number, that enables the central processing system to access the account. At step 709 the central processing system validates the account information, and then stores the information in a secure database for use by the Central Processing System for initiating transactions and managing settlement. A consumer can link many accounts to their Mobile Wallet, and can designate a primary account for payment.

At step 710 the consumer is able to select from a menu option that enables them to add value from pre-funded gift card IDs to their Mobile Wallet. At step 711 the consumer selects from a menu on their Mobile Device, Web page, or other authorized device, to select the card type and/or merchant name for the card they wish to enter. At step 712, the consumer enters information for the gift card ID into the system, which may include, but is not limited to, the card number, PIN code and other values as may be deemed necessary. This step may be repeated multiple times for multiple gift card IDs. At step 713 the central processing system performs a balance inquiry transaction on each active gift card, and returns balances in total, by merchant, for the consumer to view on their Mobile Device, Web page, or other authorized device.

At step 714 the consumer is able to use their Mobile Device, Web page, or other authorized method to access, view and filter their purchase transaction history. At step 715 the consumer uses a menu to select how they would like to view the summary of purchases by using filters including, but not limited to, date range, merchant, purchase amount, Reward and/or Loyalty point value, and other criteria as deemed necessary. At step 716, the central processing system accesses their transaction history and displays the results to the consumer on their Mobile Device, Web page, or other authorized device.

FIGS. 8a and 8b detail methods by which Promotional value can be associated with consumer transactions and/or accounts. Referring initially to FIG. 8a, at step 801, participating Merchants will log into the central processing system using a secure Web page. At step 802, the Merchant will establish the event-based rules that will determine when consumers will receive Promotional value. Triggers can include, but not be limited to, amount of total spend, number of transactions over a specific time period, amount of spend over a specific time period, basket of items purchased, or other triggers as deemed necessary. At step 803, Merchants can define the type of value to be applied, which can include but is not limited to: loyalty points, funds deposited to a customer's linked bank account, value applied to a transaction, or funds assigned to the merchant's specific closed loop gift card ID. At step 804, the Merchant can define when the Promotional Value would be applied, and options can include, but are not limited to, concurrently with the POS transaction or post-tender of the transaction.

Referring now to FIG. 8b, at step 805, the consumer has initiated a transaction which triggers the Central Processing system to query the Promotional sub-system at step 806. At step 807, the Promotional sub-system the transaction is processed by the Promotional rules engine to determine if an event should be triggered. If the rules indicate that no value should be applied, then the transaction is processed as per normal (step 808). At step 809, if the Promotional sub-system determines whether the event should be applied dynamically to the active transaction, or should result in value being placed post-tender into the consumer's account. If the result is to the consumer's account, then a message is triggered to insert the value with the appropriate currency (step 810). If the resulting Promotional value is to be applied to the current transaction, then at step 811 the total transaction amount would be reduced by the value of the event (if the value type was funds), and a message could be presented to the consumer via their Mobile Device. At step 812, once the total adjusted value of the transaction was determined, the consumer would be prompted to complete the transaction through the POS tender.

FIG. 9 details a method to dynamically alter the amount associated with a Payment ID to reflect the application of a promotion. Upon the on-demand retrieval or generation and funding of a Payment ID, the Central Processing System (element D) will apply Promotion Rules (element Q) to the transaction to determine if a promotion applies to the specific transaction. Promotion Rules (element Q) may include specific value (e.g., cash value, discount, a product, a service or some other promoted value the merchant wishes to deliver to the consumer), which is tied to the merchant ID, the time of day, geography, or any other attribute that can be tracked for the purpose of applying a promotion.

Once the Promotion Rules (element Q) are applied, any applicable Promotion(s) (element R) is identified and logged within the Transaction Database (element H) along with all other data associated to that transaction. A Promotion (element R) may include any value due the consumer such as a percent or absolute discount applied to the current transaction, a percent or absolute discount applied to a future transaction, a product or service upgrade, or any other promotion the merchant has decided to offer.

If the Promotion(s) (element R) is applicable to the current transaction, data is sent to the Payment ID Management System (element I) to dynamically adjust the transaction amount associated with the Payment ID. This adjustment will be sent to the Account Management System (element E), which, if applicable, will dynamically adjust the value drawn down from the consumer's account to fund the Payment ID. The specific process leveraged by the Payment ID Management System (element H) and the Account Management System (element E) to dynamically alter payment amounts will be based on the processes employed by the specific merchant, the processor of that merchant's gift cards, the Promotion (element R) and any other relevant factors. For example, in some scenarios, the value of the Payment ID may be dynamically adjusted; in others, the value of the Payment ID will remain the same, but the amount pulled from the consumer's account will be adjusted; in others, both values may change; in others, neither will change and settlement will occur after the transaction; etc.

Should the application of a Promotion (element R) result in the need to settle values across involved parties, the Payment Processing System (element S) will create an Invoice (element T) for submission to the relevant party(ies). Invoices (element T) are batched at period intervals (e.g., daily) and sent to the party(ies) that are involved in the processing of a specific Promotion (element R). The settlement process depends on the currency involved with the Promotion (element D), which can include cash value or some other measurement of value distributed to the consumer, and the type of the event (e.g., synchronous, asynchronous, real-time or batch). All details tied to a Promotion (element R) will be stored within the Transaction Database (element H) to support subsequent reporting.

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA®, or a domain specific language, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for funding a transaction between a consumer and a merchant. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
receiving, at a central processing system, a request for a payment ID from a consumer;
retrieving a closed-loop, merchant-specific payment ID from a payment ID database;
activating the payment ID; and
funding the payment ID on-demand with a specific, consumer-requested amount.

2. The method of claim 1, wherein the closed-loop payment ID is sourced directly from an entity responsible for processing a specific merchant's closed-loop payment transactions.

3. The method of claim 1, wherein the closed-loop payment ID is sourced from a secure database within the central processing system, which houses an inventory of inactive, closed-loop payment IDs that had been previously provided to the central processing system by the merchant or the entity responsible for processing the merchant's closed-loop payment transactions.

4. The method of claim 1, wherein the closed-loop payment ID is sourced from a secure database within the central processing system that houses an inventory of previously used, but reloadable, payment IDs and payment IDs previously purchased and provided by the consumer.

5. The method of claim 1, further comprising:
validating, by the central processing system, that the consumer has a sufficient balance to fund the payment ID in the requested amount prior to retrieving a payment ID.

6. The method of claim 1, further comprising:
pulling, by the central processing system, funds from an existing consumer account to fund a payment ID in the requested amount after the payment ID has been retrieved.

7. The method of claim 1, wherein the customer authorizes funds to be pulled in real time from an external account to fund a payment ID in the requested amount.

8. The method of claim 1, wherein the consumer loads funds into a secure account by providing account IDs to the central processing system from which funds can be drawn and wherein the secure account comprises one or more of a funded closed-loop gift card account, an open-loop prepaid/debit card accound, and a bank routing number.

9. The method of claim 8, wherein the account is one of (i) merchant-specific and (ii) for use across multiple merchants.

10. A method, comprising:
receiving an active, closed-loop payment ID from a central processing system; and
using the active, closed-loop payment ID to complete a payment transaction with a merchant during an active tender process through the merchant's point of sale system by leveraging the existing integration between the merchant and an entity that processes that merchant's closed-loop payment transactions.

11. The method of claim 10, wherein the active, closed-loop payment ID is received at a communication device held and operated by a consumer, the method further comprising:
rendering, on the communication device, the funded, closed-loop payment ID.

12. The method of claim 11, wherein the funded, closed-loop payment ID is visibly rendered on a user interface of the communication device as at least one of a barcode and a set of viewable digits.

13. The method of claim 12, further comprising:
communicating the rendered payment ID from the communication device to the point of service system such that it can be processed by the point of service system to complete a payment transaction.

14. The method of claim 12, wherein the payment ID is rendered as a barcode in a format that is recognizable by the specific merchant's point of service system.

15. The method of claim 12, wherein the funded, closed-loop payment ID is rendered a human-readable code such that it can be manually input into the merchant's point of service system and processed to complete a payment transaction.

16. The method of claim 10, further comprising:
transmitting, by the central processing system, the funded closed-loop payment ID to the merchant's point of service system such that it can be processed to complete a payment transaction.

17. The method of claim 16, wherein the funded closed-loop payment ID transmitted to the merchant point of service system includes a unique consumer or transaction identifier and wherein a consumer also enters a unique consumer or transaction identifier at the merchant point of service system for comparison against the unique consumer or transaction identifier provided in the funded, closed-loop payment ID to validate the payment transaction.

18. The method of claim 10, further comprising:
transmitting the funded, closed-loop payment ID to a communication device held by a consumer that has the ability to communicate wirelessly with the merchant's point of service system (e.g., via near-field communication, or NFC, technology), and
transmitting the funded, closed-loop payment ID wirelessly from the communication device to the merchant's point of service system to complete a payment transaction.

19. The method of claim 10, wherein the funded, closed-loop payment ID is input into and processed by a merchant's website to complete an online, ecommerce transaction.

20. A computer-implemented method, comprising:
receiving a set of rules which govern a merchant's ability or desire to provide a consumer incentive that includes at least one of promotional offers, coupons, discounts, consumer-relevant messages, and price adjustments;
delivering the consumer incentive to the consumer;
receiving a funded, closed-loop payment ID from the consumer at the merchant's point of service system, wherein the payment ID was at least partially funded with the consumer incentive and wherein a payment value associated with the payment ID represents a total funding amount requested by the consumer less the consumer incentive.

21. The method of claim 20, wherein a central processing system applies the business rules to an active transaction and pulls a corresponding message from a secure database for transmission and presentation to the consumer or merchant along with the transmission and presentation of the funded, closed-loop payment ID.

22. The method of claim 20, wherein a central processing system applies business rules to an active transaction, which result in the dynamic adjustment of the funded value of a closed-loop payment ID, and also results in the dynamic adjustment of the funds pulled from the consumer's account to reflect the newly adjusted amount attached to the closed-loop payment ID.

23. The method of claim 20, wherein a message presented to the consumer contains a human or machine-readable element which is processable by the merchant POS system during an active tender process to adjust the payment amount due from the consumer.
